(19) United States
(12) Patent Application Publication
(10) Pub. No.: US 2026/0061817 A1
(43) Pub. Date: Mar. 5, 2026

(54) VEHICLE FRAME STRUCTURE

(71) Applicant: TOYOTA JIDOSHA KABUSHIKI KAISHA, Toyota-shi (JP)

(72) Inventor: Katsunori HIGASHIHARA, Toyota-shi (JP)

(73) Assignee: TOYOTA JIDOSHA KABUSHIKI KAISHA, Toyota-shi (JP)

(21) Appl. No.: 19/095,254

(22) Filed: Mar. 31, 2025

(30) Foreign Application Priority Data
Aug. 28, 2024 (JP) 2024-146210

(51) Int. Cl. B60K 1/04; B62D 25/20

(52) U.S. Cl. CPC B60K 1/04; B62D 25/2036; B60K 2001/0438

(57) ABSTRACT

The bracket connects the side member and the cross member. The side member is an aluminum-made square tubular member. The cross member is an iron-made square tubular member. The bracket includes an abutment wall and a pair of clamping flanges. The abutment wall abuts on the tubular end portion at the end of the cross member in the vehicle width direction. The clamping flanges extend from the abutment wall to the outer side in the vehicle width direction to clamp the side member in the vertical direction.

### CROSS-REFERENCE TO RELATED APPLICATION

This application claims priority to Japanese Patent Application No. 2024-146210 filed on August 28, 2024. The disclosure of the above-identified application, including the specification, drawings, and claims, is incorporated by reference herein in its entirety.

### BACKGROUND

### Technical Field

In the present specification, a vehicle frame structure is disclosed.

### Description of Related Art

A frame structure of a vehicle includes a side member and a cross member. The side member is disposed on an outer side in a vehicle width direction. In addition, the side member extends in a vehicle front-rear direction. The cross member extends in the vehicle width direction. That is, the cross member is disposed to cross from one side surface of the vehicle toward the other side surface of the vehicle.

For example, in Japanese Unexamined Patent Application Publication No. 7-172349 (JP 7-172349 A), both a side member (side frame) and a cross member (cross frame) are made of an aluminum extrusion material. An end portion of the cross member in the vehicle width direction is connected to the side member. The cross member has a square tubular shape. A plurality of block-shaped ribs is provided on a side surface of the side member. A slit is provided between adjacent ribs. The cross member is disposed in the slit.

In addition, in Japanese Unexamined Patent Application Publication No. 2017-24490 (JP 2017-24490 A), a bracket is interposed between a cross member and a side member (rocker).

### SUMMARY

In a case of a side collision of the vehicle, a collision load inward in the vehicle width direction is applied to the side member. At this time, the cross member restrains the side member. Here, in a case where the cross-sectional center of gravity of the side member and the height-direction center of the cross member are misaligned, the side member may be twisted (fall) around the cross-sectional center of gravity.

In addition, in a case where the cross member has a square tubular shape, a side surface of the side member is in line contact with a tubular end portion of the cross member. Here, in a case where the side member is made of aluminum, the deformation aspect of the side member is a local elongation (point elongation). That is, the deformation load is concentrated on the line contacted portion, unlike the uniform elongation in which the deformation start point and the vicinity thereof are uniformly deformed. Therefore, there is a possibility that a crack may occur at a place where a load is applied.

Therefore, in the present specification, a vehicle frame structure is disclosed in which twisting of a side member at the time of a side collision at a connecting portion between a cross member and a side member can be suppressed and cracking of the side member can be suppressed.

In the present specification, a vehicle frame structure is disclosed. The structure includes a side member, a cross member, and a bracket. The side member extends in a vehicle front-rear direction. In addition, the side member is disposed at an end portion in a vehicle width direction. The cross member extends in the vehicle width direction. The bracket connects the side member and the cross member. The side member is a square tubular member made of aluminum. The cross member is a square tubular member made of iron. The bracket includes an abutment wall and a pair of clamping flanges. The abutment wall abuts on a tubular end portion at an end of the cross member in the vehicle width direction. The clamping flanges extend from the abutment wall toward an outer side in the vehicle width direction and clamp the side member in an up-down direction.

With the above configuration, the abutment wall is disposed between the tubular end portion of the cross member and the side member. As a result, the crack of the side member at the time of the side collision is suppressed. The side member is further clamped between the clamping flanges. As a result, the twisting of the side member at the time of the side collision is suppressed.

In addition, in the above configuration, the vehicle frame structure may include a battery pack. The battery pack is suspended and supported by the side member. The bracket includes a battery flange. The battery flange is fastened to an upper wall of the battery pack.

With the above configuration, the bracket is also fastened to the battery pack. As a result, the collision load applied to the side member is dispersed to the cross member and the frame of the battery pack.

In addition, in the above configuration, the vehicle frame structure may include a battery pack. The battery pack is fastened to a lower wall of the side member. In addition, the battery pack is suspended and supported by the side member. An inner wall of the side member has a step structure. An upper portion located on a relatively upper side in the inner wall protrudes inward in the vehicle width direction with respect to a lower portion located on a relatively lower side in the inner wall. Further, a connecting portion extends in the vehicle width direction. The connecting portion connects the upper portion and the lower portion. The clamping flange located on a lower side among the clamping flanges is engaged with the connecting portion.

With the above configuration, the clamping flanges are hooked on the connecting portion, such that the side member can be clamped by the clamping flanges without interfering with the fastening structure between the battery pack and the side member.

In addition, in the above configuration, a rib may be provided inside the side member. The rib extend in the vehicle width direction. At least one of an upper wall of the cross member and a lower wall of the cross member has a height position aligned with the rib.

With the above configuration, it is possible to transmit a load from the rib toward the cross member.

According to the vehicle frame structure disclosed in the present specification, the twisting of the side member at the connecting portion between the cross member and the side member at the time of the side collision is suppressed. In addition, the crack of the side member can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view illustrating a vehicle structure;

FIG. 2 is an exploded perspective view of a vehicle frame structure;

FIG. 3 is an exploded perspective view of the vehicle frame structure in a direction opposite to the front and rear of FIG. 2;

FIG. 4 is a perspective view illustrating a vehicle frame structure around a bracket;

FIG. 5 is a V-V cross-sectional view of FIG. 4; and

FIG. 6 is a V-V cross-sectional view illustrating a state of a side collision of the vehicle.

### DETAILED DESCRIPTION OF EMBODIMENTS

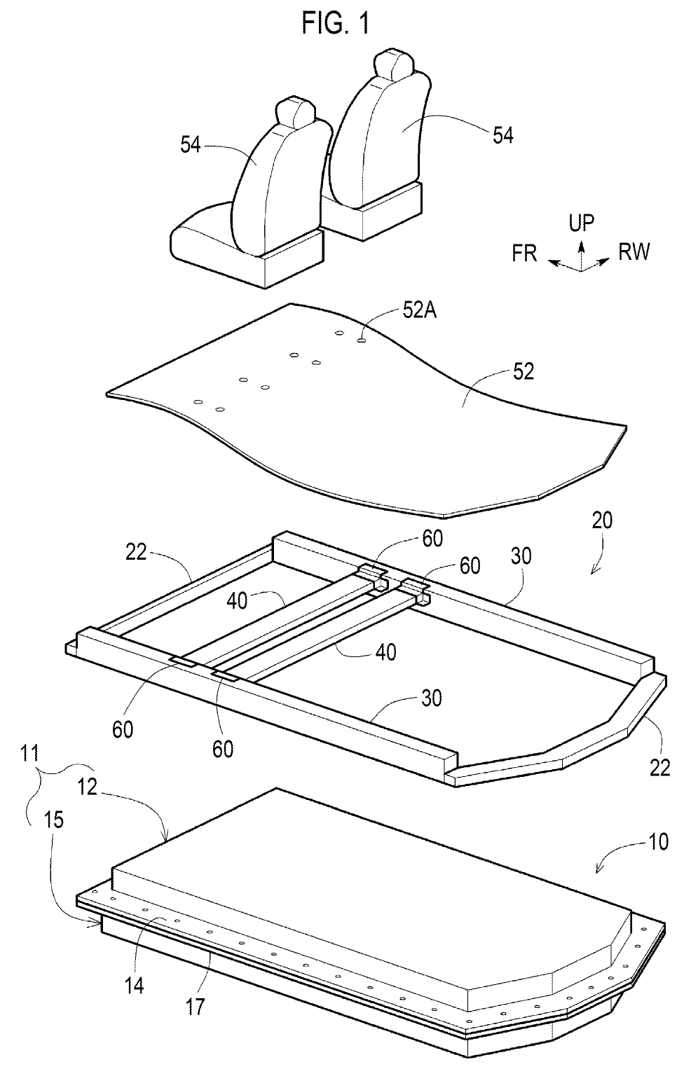

FIGS. 1 to 6 illustrate a vehicle frame structure according to the present embodiment. The vehicle frame structure according to the present embodiment is mounted on a battery electric vehicle (BEV). In addition, the vehicle frame structure according to the present embodiment includes a battery pack 10, a frame 20, a seat cross member 40, and a bracket 60.

In FIGS. 1 to 6, a vehicle front-rear direction is indicated by an FR axis. The vehicle width direction is indicated by an RW axis. The vertical direction is represented by a UP axis. The FR axis is a positive direction in front. The RW axis is defined as the positive direction in the right direction. The UP axis is the height direction as a positive direction.

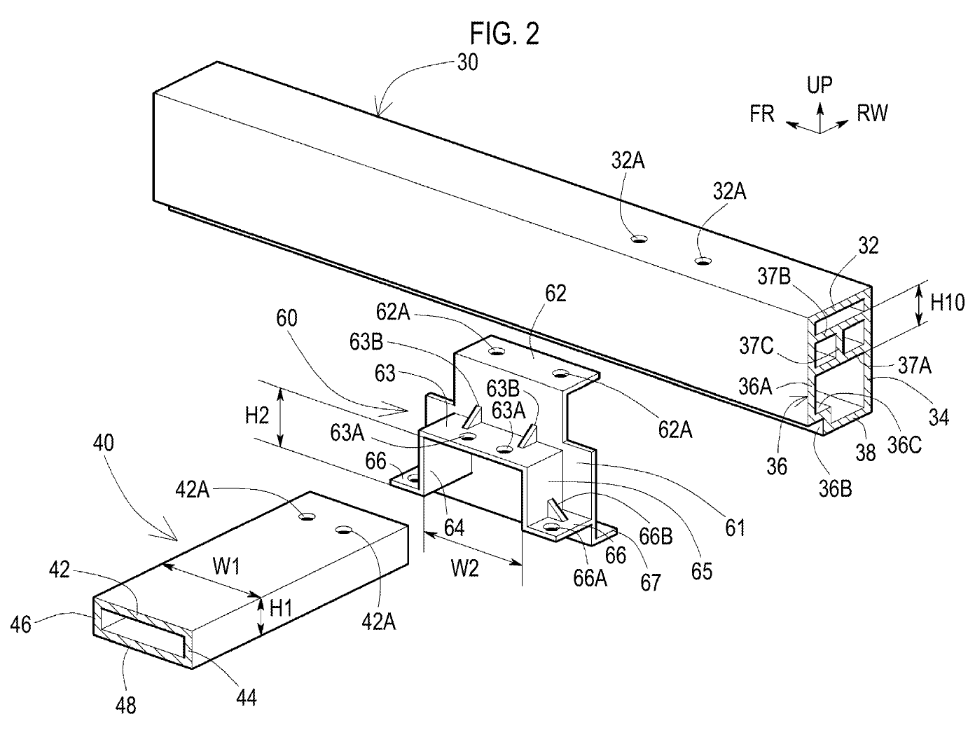

In addition, in FIGS. 2 to 6, a structure of a right side portion of the vehicle is illustrated. However, the structure of the vehicle left side portion is also based on the symmetrical structure of the vehicle body, and corresponds to FIGS. 2 to 6.

### 1. Vehicle Structure

FIG. 1 illustrates an exploded perspective view of a vehicle structure around a vehicle cabin. The battery pack 10 is disposed under the floor of the vehicle cabin. The battery pack 10 is supported by the frame 20. The frame 20 is a frame-shaped frame member. For example, the frame 20 supports the entire periphery of the battery pack 10.

The seat cross member 40 is fixed to the frame 20. The seat cross member 40 is a cross member that extends in a vehicle width direction, for example. Further, the seat cross member 40 is provided in a pair, for example, in a vehicle front-rear direction.

A floor carpet 52 is laid on the frame 20 and the battery pack 10. That is, the upper wall of the battery pack 10 also serves as a floor panel. Further, the seat 54 is fastened to the seat cross member 40 through the fastening hole 52A of the floor carpet.

### 2. Battery Pack

With reference to FIG. 1, the battery pack 10 is a box-shaped large part. For example, the battery pack 10 is disposed on a floor surface of a vehicle cabin. The battery pack 10 supplies electric power to a rotary electric machine (not shown) that is a drive source of a vehicle. The battery pack 10 is suspended and supported on the frame 20.

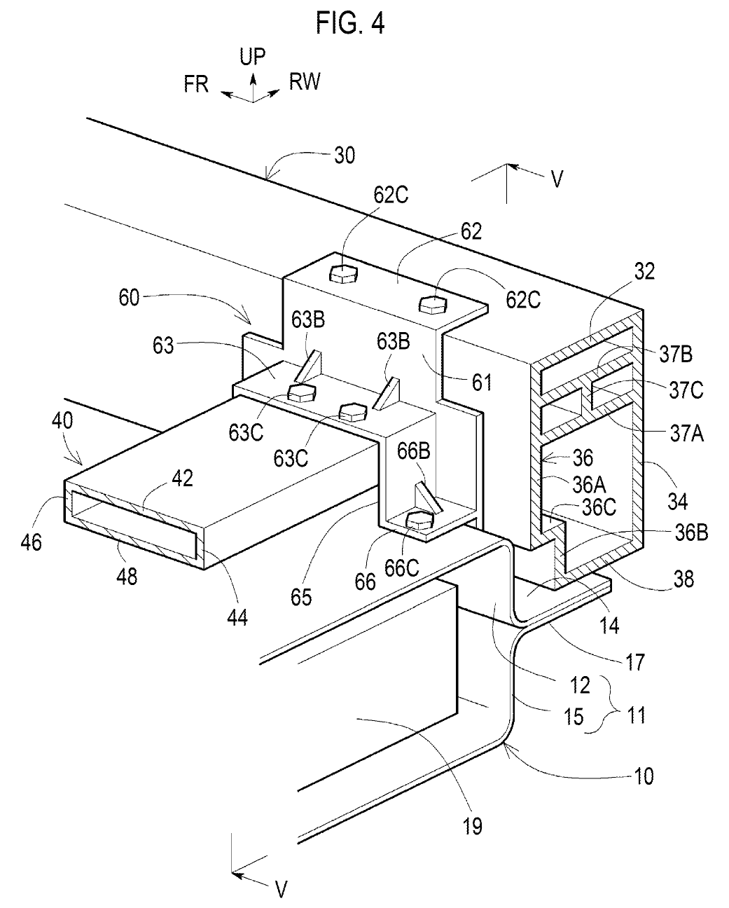

With reference to FIG. 4, the battery pack 10 includes a battery case 11 and a plurality of battery cells 19. The battery case 11 houses the battery cell 19. The battery cell 19 is constituted of, for example, a nickel-metal hydride secondary battery, a lithium ion secondary battery, or an all-solid-state battery.

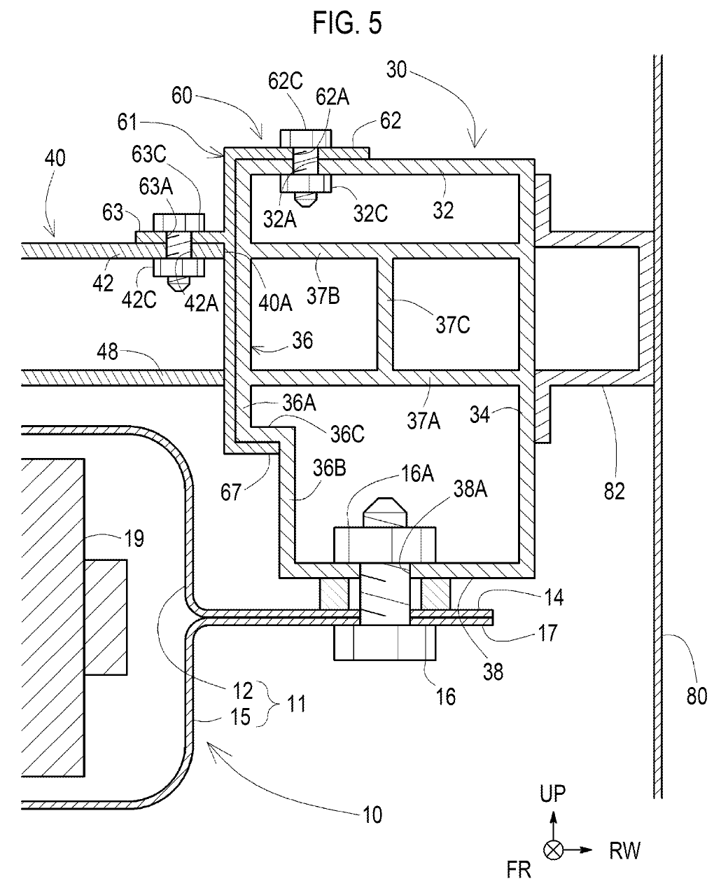

The battery case 11 includes an upper case 12 and a lower case 15. The upper case 12 and the lower case 15 include flanges 14, 17. With reference to FIG. 5, the flanges 14, 17 are fastened to the lower wall 38 of the side member 30 via the bolts 16. By fastening, the battery pack 10 is suspended and supported by the frame 20.

### 3. Frame

With reference to FIG. 1, the frame 20 is a rectangular frame member in a plan view. The frame 20 includes a pair of frame cross members 22, 22 and a pair of side members 30, 30. The frame cross member 22 and the side member 30 are manufactured by extrusion-molding an aluminum material.

The frame cross member 22 extends in the vehicle width direction. The frame cross member 22 is connected to the end portion of the side member 30 in the vehicle front-rear direction.

The side member 30 extends in a vehicle front-rear direction. In addition, the side members 30 are disposed at both ends of the vehicle in the vehicle width direction. The side member 30 is disposed at both ends of the vehicle cabin in the vehicle width direction, for example. The side member 30 is an aluminum-made square tubular member. That is, the side member 30 includes an upper wall 32, an outer wall 34, an inner wall 36, and a lower wall 38. The side wall on the outer side in the vehicle width direction is the outer wall 34. The side wall on the inner side in the vehicle width direction is the inner wall 36. The thicknesses of the wall members may be equal to the thickness of the wall member of the seat cross member 40.

Further, ribs 37A, 37B, 37C for reinforcement are provided inside the side member 30. The ribs 37A, 37B extend in the vehicle width direction. The rib 37C extends in a height direction. With reference to FIG. 2, the height H10 of the ribs 37A, 37B may be equal to the height H1 of the seat cross member 40. As will be described later, the rib 37A and the lower wall 48 of the seat cross member 40 are aligned in height position. In addition, the rib 37B and the upper wall 42 of the seat cross member 40 are aligned in height position. That is, the rib 37A and the lower wall 48 are disposed on the horizontal plane. Similarly, the rib 37B and the upper wall 42 are disposed on the horizontal plane.

With reference to FIG. 5, the lower wall 38 of the side member 30 is perforated with fastening holes 38A. The fastening hole 38A penetrates the lower wall 38. In addition, a weld nut 16A is provided in the side member 30. The weld nut 16A is disposed on the lower wall 38 so as to be coaxial with the fastening hole 38A.

As will be described later, clamping flanges 62, 67 that clamp the side member 30 up and down are provided in the bracket 60. The upper clamping flange 62 is opposed to the upper wall 32 of the side member 30. Further, the lower clamping flange 67 faces the connecting portion 36C of the side member 30.

An inner wall 36 of the side member 30 has a step structure. The step structure includes an upper portion 36A, a lower portion 36B, and a connecting portion 36C. The upper portion 36A is a portion of the inner wall 36 that is relatively higher. The lower portion 36B is a portion of the inner wall 36 that is relatively lower. The upper portion 36A protrudes inward in the vehicle width direction from the lower portion 36B. The connecting portion 36C connects the upper portion 36A and the lower portion 36B. The connecting portion 36C extends in the vehicle width direction.

The clamping flanges 62, 67 extend from the abutment wall 61 to the outer side in the vehicle width direction. The further lower clamping flange 67 is engaged with (hooked on) the connecting portion 36C of the inner wall 36. That is, the clamping flange 67 has a shape that does not inhibit the fastening of the battery pack 10 to the side member 30.

Further, the side member 30 is perforated with fastening holes 32A in the upper wall 32. In addition, a weld nut 32C is provided on the inner surface of the upper wall 32. The clamping flange 62 of the bracket 60 is perforated with a fastening hole 62A. The fastening hole 32A and the fastening hole 62A are aligned with each other, and a bolt 62C is screwed into the fastening hole 62A and the fastening hole 32A. As a result, the bracket 60 is fastened to the side member 30.

For example, the fastening surfaces of the bracket 60 and the side member 30 may be one surface of the clamping flange 62 and the upper wall 32, respectively. That is, the abutment wall 61, the upper portion 36A of the inner wall 36, the clamping flange 67, and the connecting portion 36C may not be fastened.

As illustrated in FIG. 5, a reinforcing member 82 may be provided on the outer side of the side member 30 in the vehicle width direction. For example, in a case of a side collision of the vehicle, the reinforcing member 82 is provided on the outside of the outer wall 34 to suppress the crack of the outer wall 34. The reinforcing member 82 has, for example, a cross-sectional hat shape and is welded to the outer wall 34.

### 4. Seat Cross Member

With reference to FIG. 1, the seat cross member 40 is a frame member that supports the seat 54. For example, the bottom surface of the seat 54 is fastened to the seat cross member 40 via a seat bracket (not shown).

The seat cross member 40 is a cross member that extends in the vehicle width direction. For example, the seat cross member 40 is provided in a pair at an interval in the vehicle front-rear direction. The end portions of the seat cross member 40 in the vehicle width direction are connected to the side members 30 via the brackets 60. The bonding structure will be described below.

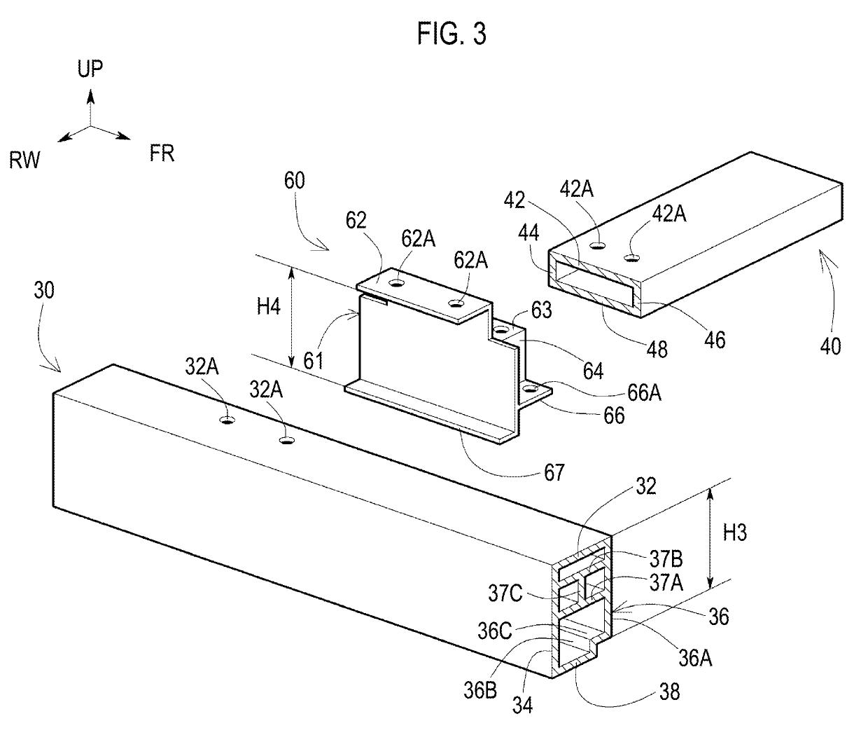

With reference to FIG. 2, the seat cross member 40 is a square tubular member. That is, the seat cross member 40 includes an upper wall 42, side walls 44, 46, and a lower wall 48. A height dimension H1 of the seat cross member 40 is smaller than a height dimension H3 (see FIG. 3) of the side member 30.

The seat cross member 40 is, for example, an iron-made square tubular member. The seat cross member 40 is, for example, an electrically sewn steel pipe. That is, the steel material is formed into a rectangular shape, and then the joint is welded, thereby obtaining the seat cross member 40.

The seat cross member 40 is perforated with fastening holes 42A in the upper wall 42. Further, with reference to FIG. 5, a weld nut 42C is provided on the inner surface of the upper wall 42. Further, the fastening hole 63A is perforated in the cross flange 63 of the bracket 60.

When the bracket 60 is fastened to the seat cross member 40, the upper wall 42 abuts on the cross flange 63. The fastening hole 42A of the upper wall 42 and the fastening hole 62A of the cross flange 63 are aligned. Then, the bolt 63C is screwed into the fastening holes 42A, 62A. As a result, the bracket 60 is fastened to the seat cross member 40.

For example, the fastening surfaces of the bracket 60 and the seat cross member 40 are merely one surface of the cross flange 63 and the upper wall 42, respectively. That is, with reference to FIG. 2, the cross flange 65 and the side walls 44, and the cross flange 64 and the side walls 46 may not be fastened.

### 5. Bracket

With reference to FIGS. 2 and 3, the bracket 60 connects the seat cross member 40 and the side member 30. The bracket 60 is obtained by, for example, press-molding a steel material. In addition, the thickness of the bracket 60 may be the same as the thickness of the seat cross member 40, for example.

The bracket 60 has a structure in which flanges protrude forward and backward of the abutment wall 61, which is a main surface. With reference to FIG. 2, cross flanges 63, 64, 65 and a battery flange 66 are extended from the abutment wall 61 toward the inner side in the vehicle width direction. For example, the cross flanges 63, 64, 65 are erected with respect to the abutment wall 61. In addition, the cross flanges 64, 65 are disposed perpendicular to the cross flange 63. That is, the cross flanges 63, 64, 65 form a wall structure surrounding three sides.

In addition, the rib 63B is provided to suppress bending deformation of the abutment wall 61 with respect to the cross flange 63. The rib 63B is provided to straddle the abutment wall 61 and the cross flange 63. Similarly, the rib 66B is provided across the cross flanges 64, 65 and the battery flange 66.

The width W2 of the cross flange 63 may be equal to the width W1 of the seat cross member 40. The width refers to a dimension along the front-rear axis of the vehicle in FIG. 2. A height dimension H2 of the cross flanges 64, 65 exceeds a height dimension H1 of the seat cross member 40. That is, as illustrated in FIG. 4, when the seat cross member 40 is fastened to the bracket 60, the seat cross member 40 and the battery pack 10 are separated from each other in a height direction.

As described above, the seat cross member 40 and the bracket 60 are fastened to the upper wall 42 and the cross flange 63. Then, the cross flanges 64, 65 clamp the seat cross member 40 in the vehicle front-rear direction. That is, the seat cross member 40 is restrained by the cross flanges 64, 65.

The battery flange 66 is connected to the lower ends of the abutment wall 61 and the cross flanges 64, 65. The battery flange 66 extends perpendicularly to the abutment wall 61 and the cross flanges 64, 65. The battery flange 66 is perforated with a fastening hole 66A for fastening the battery pack 10 (see FIG. 4).

With reference to FIG. 3, clamping flanges 62, 67 are extended from the abutment wall 61 to the outer side in the vehicle width direction. For example, the clamping flanges 62, 67 are erected on the abutment wall 61. The clamping flanges 62, 67 are erected in a direction opposite to the cross flanges 63, 64, 65.

A distance H4 between the clamping flanges 62, 67 in the height direction may be the same as the height dimension H3 of the upper portion 36A of the side member 30. That is, the clamping flanges 62, 67 clamp the side members 30 in the vertical direction.

### 6. Connection Structure of Side Member and Seat Cross Member

With reference to FIG. 3, the clamping flanges 62, 67 of the bracket 60 clamp the side member 30. In this state, the fastening holes 62A, 32A are aligned. The bracket 60 clamps the side member 30 in the vertical direction, but does not restrain the side member 30 in the vehicle front-rear direction. Therefore, by sliding the bracket 60 with respect to the side member 30, the fastening holes 62A, 32A are aligned. After the shaft alignment, bolts 62C (see FIG. 5) are screwed into the fastening holes 62A, 32A. As a result, the bracket 60 is fastened to the side member 30.

Further, with reference to FIG. 2, the seat cross member 40 is fitted to the cross flanges 63, 64, 65. For example, the seat cross member 40 may be fastened to the side members 30, 30 at both ends in the vehicle width direction. In such a case, the seat cross member 40 is disposed in the frame from below the U-shaped frame by the cross flanges 63, 64, 65.

When the fastening holes 42A, 62A are aligned, a bolt 63C (see FIG. 5) is screwed in. As a result, the seat cross member 40 is fastened to the bracket 60. That is, the seat cross member 40 and the side member 30 are fastened via the bracket 60.

With reference to FIG. 5, the upper wall 42 of the seat cross member 40 is aligned with the rib 37B in the height position. In addition, the lower wall 48 is aligned in height position with the rib 37A. With such a disposition, the load is smoothly transmitted from the side member 30 to the seat cross member 40. In addition, in the embodiment of FIG. 5, at least one of the upper wall 42 and the lower wall 48 may have the same height position as the ribs 37A, 37B.

With reference to FIG. 5, a tubular end portion 40A at the end of the seat cross member 40 in the vehicle width direction abuts against the abutment wall 61 of the bracket 60. In addition, the side members 30 are clamped by the clamping flanges 62, 67 in the vertical direction.

In addition, the battery flange 66 of the bracket 60 is fastened to the upper wall of the battery pack 10. Specifically, the battery flange 66 and the upper case 12 are fastened with bolts 66C (see FIG. 4).

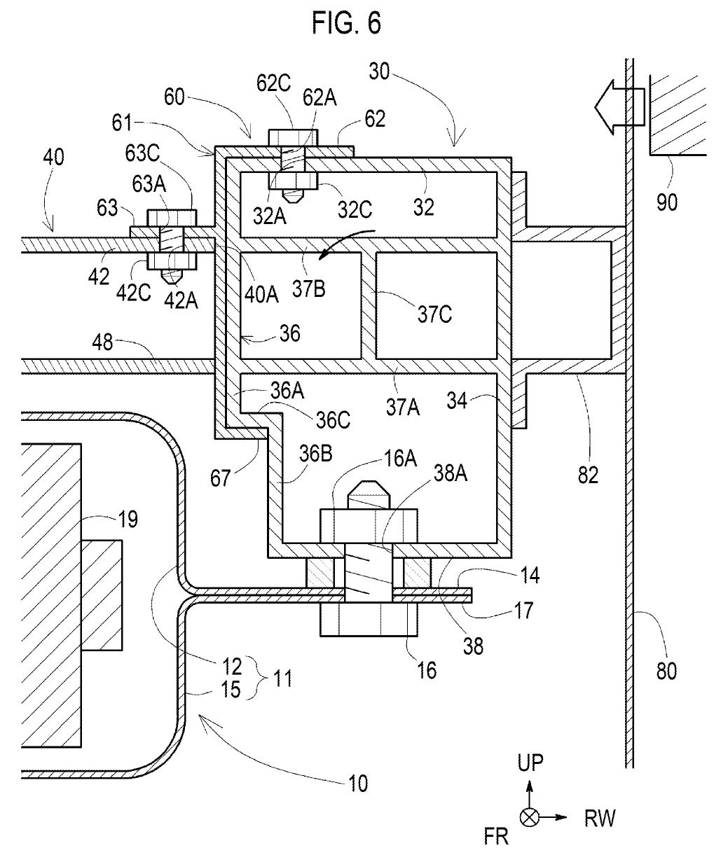

With reference to FIG. 6, a collision test item of the vehicle includes a collision test using a mobile progressive deformable barrier. In the test, the barrier collides with the vehicle during a stop. In the side collision test of the vehicle using the movable variable barrier, as illustrated in FIG. 6, the barrier 90 collides with the rocker panel 80. The barrier 90 enters from above the side member 30, for example, to the inner side in the vehicle width direction.

At this time, the side member 30 receives the collision load from the barrier 90. Further, the side member 30 receives the seat cross member 40. At this time, a moment counterclockwise with respect to the paper occurs in the side member 30 such that the side member 30 is twisted around the section center of gravity P1.

The twisting of the side member 30 is suppressed by the clamping flanges 62, 67. That is, the clamping flanges 62, 67 clamp the side member 30 up and down to suppress deformation of the side member 30.

Further, when the side member 30 is received by the seat cross member 40, the tubular end portion 40A of the seat cross member 40 abuts on the inner wall 36 of the side member 30 via the abutment wall 61. That is, the load (reaction load) of the tubular end portion 40A is input to the inner wall 36 in a state where the load is dispersed on the abutment wall 61 in a planar manner. As a result, the crack of the inner wall 36 is suppressed.

What is claimed is:

1. A vehicle frame structure comprising:
a side member extending in a vehicle front-rear direction and disposed at an end portion in a vehicle width direction;
a cross member extending in the vehicle width direction; and
a bracket configured to connect the side member and the cross member, wherein:
the side member is a square tubular member made of aluminum;
the cross member is a square tubular member made of iron; and
the bracket includes
an abutment wall abutting on a tubular end portion at an end of the cross member in the vehicle width direction, and
a pair of clamping flanges configured to clamp the side member in an up-down direction, the clamping flanges extending from the abutment wall toward an outer side in the vehicle width direction.

2. The vehicle frame structure according to claim 1, further comprising a battery pack suspended and supported by the side member,
wherein the bracket includes a battery flange fastened to an upper wall of the battery pack.

3. The vehicle frame structure according to claim 1, further comprising a battery pack fastened to a lower wall of the side member and suspended and supported by the side member, wherein:
an inner wall of the side member has a step structure, in which an upper portion located on a relatively upper side in the inner wall, protrudes inward in the vehicle width direction with respect to a lower portion located on a relatively lower side in the inner wall;
a connecting portion configured to connect the upper portion and the lower portion extends in the vehicle width direction; and
the clamping flange located on a lower side among the clamping flanges is engaged with the connecting portion.

4. The vehicle frame structure according to claim 1, wherein:
a rib extending in the vehicle width direction is provided inside the side member; and
at least one of an upper wall of the cross member and a lower wall of the cross member has a height position aligned with the rib.
